(19) United States
(12) Patent Application Publication
(10) Pub. No.: US 2012/0163512 A1
(43) Pub. Date: Jun. 28, 2012

(54) PROCESSING NODES AND METHODS OF ESTIMATING INTERFERENCE IN A RADIO TELECOMMUNICATION NETWORK

(76) Inventors: Niklas Johansson, Uppsala (SE); Fredrik Gunnarsson, Linkoping (SE)

(21) Appl. No.: 13/393,704

(22) PCT Filed: Nov. 6, 2009
(86) PCT No.: PCT/SE2009/051265

§ 371 Date: Mar. 1, 2012

(51) Int. Cl. H04B 1/10

(52) U.S. Cl. 375/340

(57) ABSTRACT

A processing node (10) for a radio telecommunications network (1) comprising an input (11) for radio signals, a receiver (12) arranged to detect radio signals received at the input (11) and a code-detecting circuit (14) coupled to the receiver arranged to determine the presence of any of a first set of codes, typically preamble codes such as those employed in the UMTS system, in the received signal, in which the processing node (10) further comprises an interference-determining circuit (20) coupled to the receiver (12), arranged to perform a comparison of the received signals with a second set of codes that are orthogonal to the first set of codes. This can enable a determination of the impairment covariance in the received signals to be determined, and hence be used to suppress or whiten noise and interference.

### TECHNICAL FIELD

This invention relates to processing nodes such as may typically be used in radio telecommunication networks, in particular as radio base stations, and a method of estimating interference in such a network.

### BACKGROUND

Common radio telecommunication networks comprise a plurality of User Equipment (UE), which are the mobile terminals by which a subscriber can access services offered by the operator's Core Network (CN). The Radio Access Network (RAN) is the part of the network that is responsible for the radio transmission and control of the radio connection. In one example network, the Wideband Code Division Multiple Access (WCDMA) technology according to the Third Generation Partnership Project (3GPP), the Radio Network Subsystem (RNS) controls a number of Base Stations in the radio access network.

The Radio Network Controller (RNC) controls radio resources and radio connectivity within a set of cells. The BS (Base Station) handles the radio transmission and reception within one or more cells. A cell covers a geographical area. The radio coverage in a cell is provided by radio base station equipment at the base station site. Each cell is identified by a unique identity, which is broadcast in the cell. There may be more than one cell covering the same geographical area.

Similarly, in the Long Term Evolution (LTE) technology according to 3GPP, both the features of the RNC and the base station are carried out by the eNodeB. Whilst reference below is made to base stations and RNCs, the issues raised by the prior art are equally applicable to the eNodeB of the LTE system.

For random access to such networks, the user equipment in their idle state monitors the system information of a base station within range to inform itself about candidate base stations in the service area. When a user equipment needs access to services, it sends a request to the network. In the example of WCDMA networks, this request is sent over the random access channel (RACH) between the user equipment and a radio network controller (RNC) via the most suitable base station, typically the one with the most favourable radio conditions.

The RACH transmission in WCDMA is divided into two parts: a preamble and a message part (according to Third Generation Partnership Project (3GPP) technical specification 3GPP TS 25.214 section 5.2.2.1). First, one or more preambles are transmitted by the user equipment.

Since the uplink propagation is only approximately known, the user equipment gradually increases the transmission power of each preamble until either the base station has acknowledged the successful detection of the preamble, typically via the Acquisition Indicator channel (AICH), or the maximum number of preamble transmission attempts has been reached. Upon acknowledgement, the RACH message is sent (as described in the 3GPP technical specifications 3GPP TS 25.214 and 3GPP TS 25.211).

Each user equipment selects a preamble at random among the up to 16 preambles that are available in each cell according to 3GPP technical specification 3GPP TS 25.213. Each preamble of length 4096 chips is constructed from signature sequences that are scrambled with a scrambling code. The signature sequences are 256 repetitions of orthogonal 16-chip Hadamard sequences.

A typical preamble detector uses a matched filter that is matched to the preamble signal, or part thereof. Often the power of the output of the matched filter is divided by a noise-and-interference power estimate and compared to a detection threshold. This threshold could be configured by the radio network controller and applied at the radio base station. If the threshold is set too low, then noise and interference is likely to produce false matches, which will trigger allocation of network and base station resources to no purpose. A too low threshold would for detected preambles also mean that the user equipment would transmit its subsequent RACH message at too low power level, and so not be correctly received. If the threshold is set too high, then preambles will only be detected at unnecessarily high transmission powers, or not at all. The threshold may need to be set considering the worst case uplink load situation.

The uplink transmission resources in CDMA are limited by the interference level the base station receiver can handle. The interference level is often measured as the rise over thermal (RoT), the total amount of interference and noise compared to the thermal noise level. Limiting the RoT is either motivated by the coverage requirement or power control stability requirements. When only one user is connected in the cell, bother power control stability and coverage are usually minor issues, since the uplink interference is likely to be dominated by the power generated by this user. In such a case it is tempting to allow a high RoT to enable a higher signal-to-noise-and-interference ratio of the signal received from the user. This would, in turn, enable higher data rates for the user. Cells operating at high RoT will, however, have limited coverage and it might not be possible to successfully complete random access from some parts of the cell's service area.

However, when a particular user or a few users dominate the received signal at a base station, the interference they give rise to perceived at the preamble detector is coloured (that is, samples of the noise and interference correlate with each other). Performance gains can be achieved by estimating the correlation of the interference over time and employing interference suppression or whitening, so that the noise and interference do not correlate.

In LTE, the preamble sequences are segments from one or several Zadoff-Chu sequences, and all segments from the same Zadoff-Chu sequence are essentially orthogonal. The number of needed Zadoff-Chu sequences depends on the cell range—wider cells need longer segments from the sequences and therefore more Zadoff-Chu sequences are needed to construct the needed 64 preambles. In addition, there is a high speed mode, supporting mobiles at high speed. In this mode, fewer preambles can be generated from each Zadoff-Chu sequence. The preambles are divided into ‘random’ and ‘dedicated’, where the latter is allocated by the base station to a specific mobile, which means that no other mobile can be using the same preamble at the same time in the same cell.

Interference suppression techniques have potential benefits in theory, but require efficient means to estimate the covariance properties of the interference and noise.

### SUMMARY

According to a first aspect of the invention, there is provided a processing node for a radio telecommunications network comprising an input for radio signals, a code-detecting circuit coupled to the input and arranged to determine the presence of any code of a first set of codes in the received signal, in which the processing node further comprises an interference-determining circuit coupled to the input, arranged to perform a comparison of the received signals with a second set of codes that are orthogonal to the first set of codes.

The inventors have appreciated that the comparison of the received signal with a code that is orthogonal to codes whose presence is being determined is indicative of the level of interference in the received signals, and in particular indicative of the covariance of the interference, especially where the received signal comprises at least one of the first set of codes. Typically, the first set of codes comprises or consists of at least one, but typically a plurality of preamble codes. The second set of codes may comprise one or more codes.

The interference determining circuit may be arranged so as to output an indication of an impairment, typically an impairment covariance, of the receiver based upon the comparison. The inventors have appreciated that comparing a received signal comprising one of the first set of codes to a code that is orthogonal to the first set of codes can result in such a value.

Given that characteristics of the interference are now known or at least estimated, the processing node may comprise an interference suppression circuit, which applies the comparison to the received signals so as to suppress interference in the received signals, typically before the presence of the first set of codes is determined. Alternatively, the comparison may form part of the step of determining the presence of any of the first set of codes in the received signal.

The processing node may have at least one area of memory in which is stored at least one of, on the first hand, the first set of codes and, on the second hand, the second set of codes. This may enable speedy lookup of the codes.

The first set of codes may be mutually orthogonal, typically by comprising or consisting of a set of Hadamard codes. Each of the first set of codes may comprise or consist of a generator code, typically a Hadamard code, sequentially repeated by a repeat factor.

In such a case, the second set of codes may be obtainable or obtained by, for each of the generator codes, taking a vector representing the generator code and having a length equal to the length of the generator code, substituting the product of that vector and each respective element of a Hadamard matrix of the same size as the repeat factor for the respective element, then taking each of the rows of the product matrix other than that forming the respective code as one of the second set of codes.

The interference determining circuit may be arranged to carry out the comparison for a plurality of time lags of the received signals relative to the second set of codes. This allows for a code of the first set of codes to arrive at differing times in the received signal.

The network may be, for example, a WCDMA (Wideband Code Division Multiple Access), UMTS (Universal Mobile Telecommunications System) or 3GPP LTE (Long Term Evolution) network. The processing node may be a node such as a radio base station or eNodeB of such a network, comprising a receiver through which the code-detecting circuit is coupled to the input and which is arranged to detect radio signals received at the input. Alternatively, the processing node may be any other node where radio signal are processed, the radio signals being detected at another node.

According to a second aspect of the invention, there is provided a method of estimating interference in at least part of a radio telecommunications network, comprising the steps of receiving radio signals at a station, detecting the presence of any code of a first set of codes in the received signals, performing a comparison of the received signals to a second set of codes that are orthogonal to the first set of codes and using the comparison to estimate the interference.

The first set of codes may comprise or consist of a plurality of preamble codes. Particularly where the received signal comprises one of the first set of codes, this comparison has been found to be indicative of the level of interference in the received signals, and in particular the covariance of the interference. The method will typically therefore include determining an indication of the impairment, typically the impairment covariance, of the station based upon the comparison.

The method may further comprise applying the comparison to the received signals so as to suppress interference in the received signals, typically before determining the presence of the first set of codes. Alternatively, the comparison may form part of the step of detecting the presence of any of the first of codes in the received signals.

The first set of codes may be mutually orthogonal, typically by comprising or consisting of a set of Hadamard codes. Each of the first set of codes may comprise or consist of a generator code, typically a Hadamard code, sequentially repeated by a repeat factor.

The second set of codes may be obtainable or obtained by, for each code of the first set of codes, taking a vector representing the generator code having a length equal to the length of the generator code, substituting the product of that vector and each respective element of a Hadamard matrix of the same size as the repeat factor for the respective element to form a product matrix, then taking each of the rows of the product other than that forming the code of the first set of codes as one of the second set of codes.

The comparison may be carried out for a plurality of time lags of the received signals relative to the second set of codes.

### BRIEF DESCRIPTION OF THE DRAWINGS

FIG. 1 shows a radio telecommunications network according to an embodiment of the invention;

FIG. 2 shows a radio base station of the network of FIG. 1;

FIG. 3 shows a flow chart showing the processing of received signals in the radio base station of FIG. 2; and

FIG. 4 shows a table showing the preamble codes used in the network of FIG. 1.

### DETAILED DESCRIPTION

FIG. 1 of the accompanying drawings shows a radio access network 1 according to an embodiment of the present invention. Whilst this embodiment utilises the WCDMA standard, the invention is equally applicable to any other radio telecommunications standard, such as LTE or UMTS. The radio access network 1 allows access by the User Equipment UE 3 to the services provided by the radio access network operator's core network 4. The radio access network 1 comprises a plurality of radio network systems 2, each of which comprises a plurality of radio base station 10. As such, as so far described, the radio access network 10 functions as that described in the introduction.

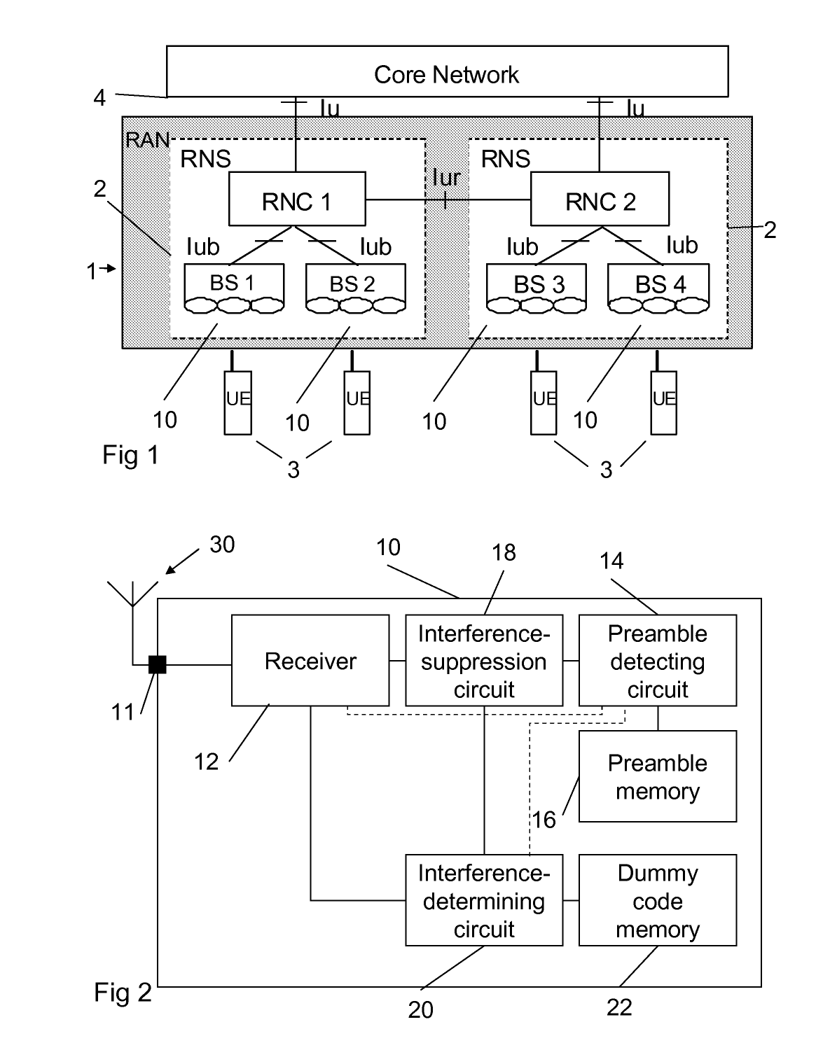

An example base station 10 is shown in FIG. 2 of the accompanying drawings. It comprises a receiver circuit 12, which receives radio signals from a plurality of antennas 30 through input 11, and detects modulated signals carried on carriers in the radio signal. Stripping the signals from the carrier results in an electronic signal indicative of the transmitted signals. These signals are passed to a preamble detecting circuit 14.

Most often, a base station random access preamble detector is designed as a power detector. It is based on a matched filter that is matched to the RACH preamble. The power of the matched filter output is divided with a noise-and-interference power estimate to obtain a decision variable (usually indicated d) that is compared to the detection threshold. As the base station does not know how far away the user equipment is, the detector must search the received signal over a search window time interval for a preamble by computing decision variables and comparing them to the threshold for a number of time lags in the received signal.

For a system with multiple antennas at the receiver, one embodiment of the decision variable can be given by:

d=y^{H}Rᵤ⁻¹y Equation 1

where d is the decision variable, y is a vector representing the matched filter outputs from each of the antennas, stacked to form the vector, H is the Hermitian or conjugate transpose of a matrix or vector and Rᵤ is an estimated covariance matrix of the noise and interference. The noise and interference, possibly containing self interference from preambles at other time lags, will in the following be referred to as impairment.

Alternatively, instead of using the decision variable given above, it is possible to first whiten the signal and then to calculate the decision variable in a decision variable according to:

$$d = \frac{{\sum }_{a = 0}^{A - 1} {\vert {z}_{a} \vert}^{2}}{{σ}_{u}^{2}} \qquad Equation 2$$

where zₐ is the output of the whitening filter for antenna a, A is the number of antennas and σᵤ² an estimate of the noise and interference; by whitening this can often be set to 1 or another constant value.

One way of constructing the whitening filter is to use the Cholesky decomposition of the covariance matrix Rᵤ into a lower-triangular matrix L so that Rᵤ=LL^{H}. Then the whitening filter transforms the matched filter output yₐ into zₐ as:

$$[ \begin{matrix}{z}_{0} \\ {z}_{1} \\ ⋮ \\ {z}_{a} \\ ⋮ \\ {z}_{A - 1}\end{matrix} ] = z = {L}^{- 1} y = {L}^{- 1} [ \begin{matrix}{y}_{0} \\ {y}_{1} \\ ⋮ \\ {y}_{a} \\ ⋮ \\ {y}_{A - 1}\end{matrix} ]$$

It is also possible to stack the matched filter outputs, not only for different antennas at a certain time lag, but also from different time lags in the received signal into the vector y. Thus, each element of y would then refer to a different antenna and time lag. In such a case, the covariance matrix Rᵤ would contain not only the spatial covariance of the impairment between antennas, but also between different time lags of the matched filter outputs, from the same or different antennas.

However, either way it is necessary to estimate the impairment covariance matrix Rᵤ in order to correct for the noise and interference. To illustrate the invention, consider this example. Let c₀ be the random access preamble code that is transmitted from a UE (being a member of a first set of preamble codes), hₐ be the channel coefficient for the channel from the UE to receiver antenna a, and nₐ be the impairment part of the received signal samples. Then the output from the matched filter matched to preamble c₀ for antenna a will be y_{0,a} as

$${y}_{0 , a} = {c}_{0}^{H} ( {{h}_{a} {c}_{0} + {n}_{a}}_{{}_{recieved samples}} ) = {c}_{0}^{H} {h}_{a} {c}_{0} + \underbrace{{c}_{0}^{H} {n}_{a}}_{= {u}_{0 , a}} = {‖ {c}_{0} \vert}^{2} {h}_{a} + {u}_{0 , a} .$$

The impairment part of the matched filter output is u_{0,a}. The covariance E{u_{0,0}_{₀}u*_{0,a}_{₁}}, where E{•} is the expectation operator and * indicates the complex conjugate, of these u_{0,a} over antennas is the content of the covariance matrix Rᵤ, with a₀ and a₁ being the indices of the elements in the matrix. However, since the matched filter output also contains the signal part ∥c₀∥² hₐ, it cannot be used for impairment covariance estimation.

As such, the inventors have appreciated that, by matching the received samples to a code c₁ hereinafter referred to as a dummy code that is not used for transmission by any UE and that is orthogonal to the desired preamble code c₀, only the impairment part of the signal is left in the matched filter output as

$${y}_{1 , a} = \underbrace{{c}_{1}^{H} {c}_{0}}_{= 0} {h}_{a} + \underbrace{{c}_{1}^{H} {n}_{a}}_{= {u}_{1 , a}} = {u}_{1 , a} .$$

Effectively, because the dummy code is orthogonal to the preamble code, the result of matching to this code removes the effect of the preamble code within the received signal, enabling noise and interference to be detected. The actual values of u_{0,a} are not required for interference suppression or whitening, only the estimated covariances of different u_{0,a}. Statistically, these will have the same covariance as u_{1,a} and therefore u_{1,a} can be used for impairment covariance estimation. Covariances can be formed based on u_{1,a} and averaged over time to obtain reliable estimates, but if there is a second set of codes cᵢ that are unused and orthogonal to the first set of preamble codes, then the matched filter output from filters matched to all or some of these unused orthogonal codes can be used to obtain reliable estimates by averaging over codes.

According to section 4.3.3 of the Third Generation Partnership Project (3GPP) Technical specification (TS) 3GPP TS 25.213 (the contents of which are hereby incorporated by reference), the random access preamble codes are constructed as follows:
1. First the 16 Hadamard codes Pₛ(n) of length 16 chips are taken from Table 3 in 3GPP TS 25.213, shown in FIG. 4 of the accompanying drawings, where s=0, 1, . . . , 15 is the signature number and n=0, 1, . . . , 15 is the chip index.
2. These Hadamard codes Pₛ(n) are repeated 256 times to obtain 16 preamble signatures C_{sig,s}(i) of length 4096 chips according to C_{sig,s}(i)=Pₛ(i modulo 16), i=0, 1, . . . , 4095.
3. Then these preamble signatures are scrambled with a preamble scrambling code S_{r-pre,n} defined in 3GPP TS 25.213, Sections 4.3.2.2, 4.3.3.2 to obtain the final random access preamble codes C_{pre,n,s} defined as:

$${C}_{pre , n , s} ( k ) = {S}_{r - pre , n} ( k ) \times {C}_{sig , s} ( k ) \times {e}^{j ( \frac{π}{4} + \frac{π}{2} k )} , \\ k = 0 , 1 , 2 , 3 , … , 4095$$

In the receiver a code matched filter matched to the final random access preamble code C_{pre,n,s} is used. It processes the received signal by multiplying a received chip sequence by the complex conjugate of C_{pre,n,s}. Because the 16 Hadamard codes Pₛ(n) of length 16 are orthogonal to each other, so will the 16 preamble signatures C_{sig,s}(i) of length 4096 be. The same scrambling code S_{r-pre,n} is applied to all the 16 preamble signatures, and each chip in the scrambling code has the same amplitude. Therefore the final 16 random access preamble codes C_{pre,n,s} will also be orthogonal to each other.

A Hadamard matrix can be constructed as

$${H}_{1} = [ 1 ]$$

$${H}_{{2}^{k}} = [ \begin{matrix}{H}_{{2}^{k} - 1} & {H}_{{2}^{k} - 1} \\ {H}_{{2}^{k} - 1} & - {H}_{{2}^{k} - 1}\end{matrix} ] , \\ k = 1 , 2 , 3 , …$$

For example, the Hadamard matrix of size 4×4 is:

$${H}_{4} = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] .$$

The rows of a Hadamard matrix are orthogonal to each other. A sequence that is repeated according to the pattern in the Hadamard matrix will construct a number of new sequences that are also orthogonal to each other.

Let for example the sequence or row vector

x=[1 −1 1]

be repeated according to the pattern in H₄:

$$\begin{matrix}J = [ \begin{matrix}x & x & x & x \\ x & - x & x & - x \\ x & x & - x & - x \\ x & - x & - x & x\end{matrix} ] \\ = [ \begin{matrix}1 & - 1 & 1 & 1 & - 1 & 1 & 1 & - 1 & 1 & 1 & - 1 & 1 \\ 1 & - 1 & 1 & - 1 & 1 & - 1 & 1 & - 1 & 1 & - 1 & 1 & - 1 \\ 1 & - 1 & 1 & 1 & - 1 & 1 & - 1 & 1 & - 1 & - 1 & 1 & - 1 \\ 1 & - 1 & 1 & - 1 & 1 & - 1 & - 1 & 1 & - 1 & 1 & - 1 & 1\end{matrix} ]\end{matrix}$$

The rows of the J matrix are now orthogonal to each other.

If one of the 16 Hadamard codes Pₛ(n) of length 16 is repeated like in the example above, but according to the 256×256 Hadamard matrix H₂₅₆ the rows of the resulting matrix will be orthogonal to each other. Each row will be of length 4096, but only the first row (the row that contains only ones in H₂₅₆) corresponds to the preamble signature C_{sig,s}(i). The other 255 rows will be orthogonal to C_{sig,s}(i). This procedure can be repeated for all 16 Hadamard codes Pₛ(n), so in total 16×255=4080 codes of length 4096 are constructed. All these 4080 codes are orthogonal to all preamble signatures.

By using all or a subset of these 4080 codes for matched filtering up to 4080 samples per antenna can be obtained at every time lag. These samples are then used for covariance estimation at that given time lag in the received signal. In this way very reliable impairment covariance estimates will be obtained. The matched filtering with all these codes might seem complex, but the Fast Hadamard Transform can be utilized to significantly lower the number of operations needed.

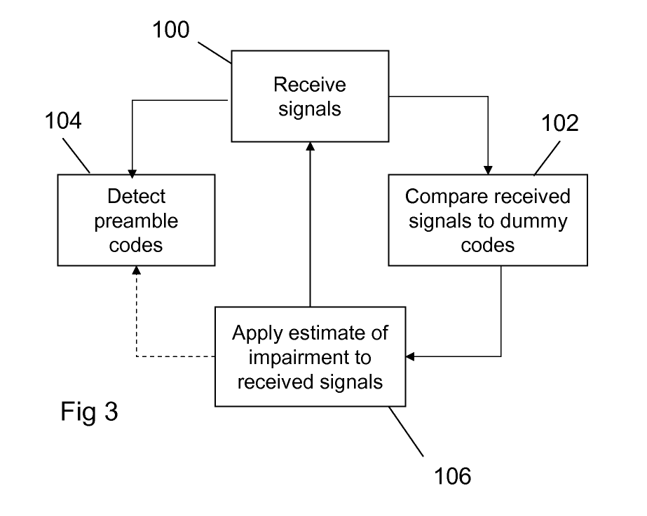

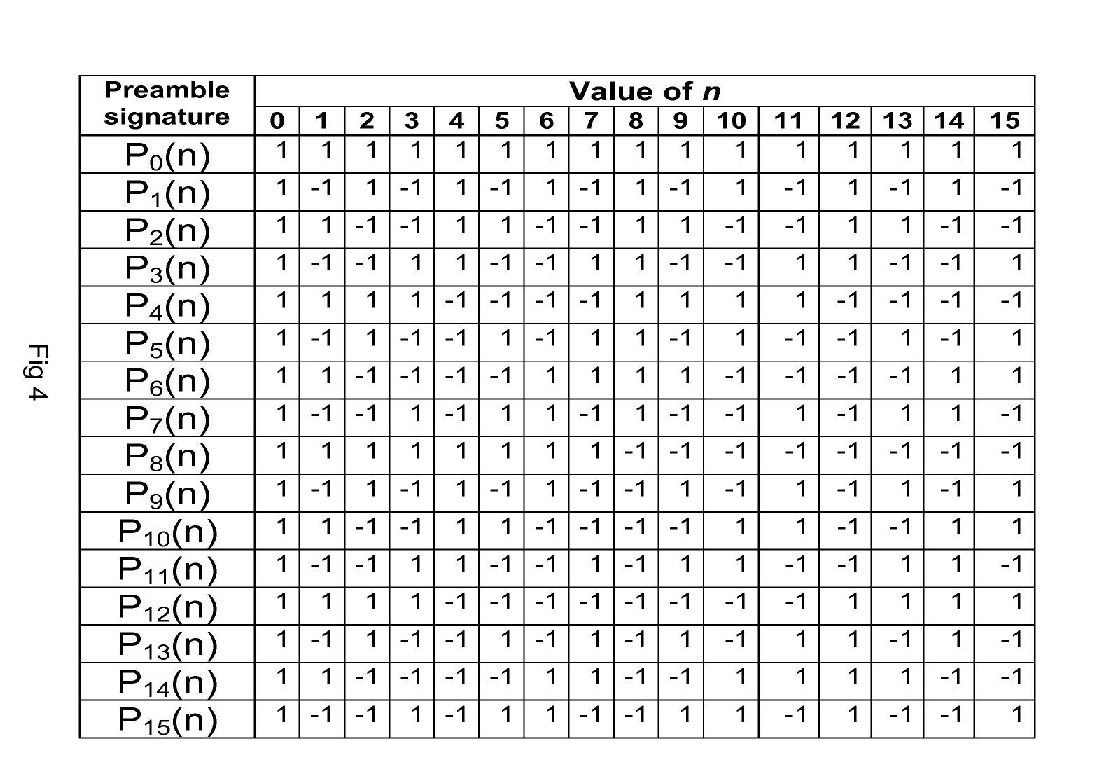

Thus, in the present embodiment of the invention, the base station 10 shown in FIG. 2 of the accompanying drawings can be used to implement the invention, and discussed with reference to the flowchart shown in FIG. 3.

In this embodiment, the received signals are detected by the receiver 12 in step 100. The received signals are passed to an interference determining circuit 20, in addition to the preamble detecting circuit 14. At step 102, the interference determining circuit 20 uses a matched filter to compare the received signals to a set of dummy codes stored in memory 22. The dummy codes are all orthogonal to the preamble codes, which are stored in memory 16 and given in the table shown in FIG. 4. They are derived by the method discussed above. Using the terminology used above, the output of the matched filter for antenna a and dummy code n is therefore u_{n,a}.

The interference determining circuit 20 then uses these values to make an estimate of the covariances of the received signals by forming covariance samples u_{n,a}_{₁}u*_{n,a}_{₂}. The covariance samples are averaged over all of the dummy codes, and used to construct an estimate of the covariance matrix Rᵤ.

Once this estimate is prepared, it can be used to directly whiten the received signals through an interference suppression circuit 18 in step 106, after which the preamble circuit can proceed to detect the preamble codes (in step 104) using a decision variable such as that shown in Equation 2 above. Alternatively (using the dotted lines shown in FIGS. 2 and 3), the estimated value of Rᵤ can be used directly in the detection of the preamble codes, using a decision variable such as that given in Equation 1. In such a case, steps 106 and 104 are carried out together, and the preamble detecting circuit and the interference suppression circuit are combined in one function.

It is also possible to do these estimations over shorter sequences than 4096 chips. For example one could do separate processing of the preamble in 4 parts. Then a 64×64 Hadamard matrix H₆₄ is used to construct 16×63=1008 unused orthogonal codes of length 1024 chips that can be used for covariance matrix estimation in each of the four parts separately.

As the time lag position in the search for a preamble in the received signal will determine if the codes are actually orthogonal to the desired preamble (only time-aligned Hadamard codes are orthogonal), in the above embodiment a new covariance matrix will need to be computed for each time lag.

A less computationally demanding implementation is to estimate the covariance in some other way in a first search for the preamble, and then in a second step covariance estimates according to this invention are computed for the most interesting and probable time lags. In the first search, the interference covariance between the antennas can be estimated, for example, by just estimating the covariance between the received samples from each antenna.

The first search can use covariance estimates based on the received samples before matched filtering, because before the matched filter that gathers all the preamble signal power the preamble signal part of the received samples is small. These covariance estimates will be proportional to the impairment covariance of the matched filter outputs, but flawed by the remaining preamble signal.

Second, to determine interesting time lags this first impairment covariance estimate can be used when searching the received signal for preambles. The detector then does not have to detect the preamble with a very low probability of false alarm, which is usually the case, but instead it can allow more uncertain time lags to be stored for further processing with the dummy code approach of this invention.

Random access in LTE is described in detail in the Third Generation Partnership Project (3GPP) Technical Standard (TS) 3GPP TS 36.211, 36.213 and 36.321. In LTE, the preambles are generated from Zadoff-Chu sequences. A Zadoff-Chu sequence of length N can be expressed, in the frequency domain, as

$${X}_{ZC}^{( u )} ( k ) = {e}^{- j π u \frac{k \cdot ( k + 1 )}{N}}$$

where u is the index of the Zadoff-Chu sequence within the set of Zadoff-Chu sequences of length N. Out of one Zadoff-Chu sequence—in the following also denoted root sequence—multiple preamble sequences can be derived by cyclic shifting. Due to the ideal ACF of Zadoff-Chu sequence multiple mutually orthogonal sequences can be derived from a single root sequence by cyclic shifting one root sequence multiple times the maximum allowed round trip time plus delay spread in time-domain. In total, 64 preambles are needed, and these are generated from consecutive Zadoff-Chu sequences.

Random access in LTE can either be subject to contention or contention-free. In the latter case, the base station reserves a preamble to a particular mobile, which means that no other mobile can use the same preamble in the same cell. This means that a reserved preamble can be used as a dummy code for segments from the same Zadoff-Chu sequence, provided that it is not allocated. Hence, dummy codes can be defined also for LTE. The calculations are equivalent, and even though the sample intervals and sequence lengths are different, the calculations, definitions and derivations for WCDMA apply.

1. A processing node for a radio telecommunications network comprising an input for radio signals, a code-detecting circuit coupled to the input and arranged to determine the presence of any code of a first set of codes in the received signal, in which the processing node further comprises an interference-determining circuit coupled to the input, arranged to perform a comparison of the received signals with a second set of codes that are orthogonal to the first set of codes.

2. The processing node of claim 1, in which the first set of codes comprises or consists of a plurality of preamble codes.

3. The processing node of claim 1, in which the interference determining circuit is arranged so as to output an indication of an impairment, typically an impairment covariance, of the received signal based upon the comparison.

4. The processing node of claim 1, further comprising an interference suppression circuit, which applies the comparison to the received signals so as to suppress interference in the received signals.

5. The processing node of claim 1, in which the interference-determining circuit and the code-determining circuit form a unified circuit operating so as to carry out the determination of the presence of the first set of codes and the comparison simultaneously.

6. The processing node claim 1, having at least one area of memory in which is stored at least one of the first set of codes and the second set of codes.

7. The processing node claim 1, in which the first set of codes are mutually orthogonal.

8. The processing node claim 1, in which the first set of codes comprises or consists of a set of Hadamard codes.

9. The processing node claim 1, in which each of the first set of codes comprises or consists of a generator code, typically a Hadamard code, sequentially repeated by a repeat factor.

10. The processing node of claim 9, in which the second set of codes are obtainable by, for each of the generator codes taking a vector representing the generator code and having a length equal to the length of the generator code, substituting the product of that vector and each respective element of a Hadamard matrix of the same size as the repeat factor for the respective element, then taking each of the rows of the product matrix other than that forming the respective code of the first set of codes as one of the second set of codes.

11. The processing node of any preceding claim, in which the first set of codes comprises or consists of a set of segments from Zadoff-Chu sequences.

12. The processing node of claim 11, in which the second set of codes are generated from the same set of sequences as the first set of codes.

13. The processing node claim 1, in which the interference determining circuit is arranged to carry out the comparison for a plurality of time lags of the received signals relative to the second set of codes.

14. A method of estimating interference in at least part of a radio telecommunications network, comprising the steps of receiving radio signals at a station, detecting the presence of any code of a first set of codes in the received signals, performing a comparison of the received signals to a second set of codes that are orthogonal to the codes of the first set of codes, and using the comparison to estimate the interference.

15. The method of claim 14, in which the first set of codes comprises or consists of at least one of preamble code.

16. The method of claim 14, including determining an indication of the impairment, typically the impairment covariance, of the station based upon the comparison.

17. The method of claim 14, further comprising applying the comparison to the received signals so as to suppress interference in the received signals.

18. The method of claim 14, in which the first set of codes are mutually orthogonal and typically comprise or consist of a set of Hadamard codes.

19. The method of claim 14, in which each of the first set of codes comprises or consists of a generator code, typically a Hadamard code, sequentially repeated by a repeat factor.

20. The method of claim 19, in which the second set of codes are obtainable or are obtained by, for each code of the first set of codes, taking a vector representing the generator code having a length equal to the length of the generator code, substituting the product of that vector and each respective element of a Hadamard matrix of the same size as the repeat factor for the respective element to form a product matrix, then taking each of the rows of the product other than that forming the code of the first set of codes as one of the second set of codes.

21. The method of claim 14, in which the comparison is carried out for a plurality of time lags of the received signals relative to the second set of codes.
